(19) United States
(12) Patent Application Publication
(10) Pub. No.: US 2014/0260159 A1
(43) Pub. Date: Sep. 18, 2014

(54) Rotary Mower with Protected Spray Nozzles

(71) Applicant: SCHULTE INDUSTRIES LTD., Engelfeld (CA)

(72) Inventor: Todd HOFMANN, Saskatoon (CA)

(73) Assignee: SCHULTE INDUSTRIES LTD., Engelfeld (CA)

(21) Appl. No.: 13/838,901

(22) Filed: Mar. 15, 2013

(51) Int. Cl. A01D 43/14

(52) U.S. Cl. CPC A01D 43/14
USPC 56/16.8

(57) ABSTRACT

A rotary mower apparatus for applying liquid chemical to vegetation has a rotating drive shaft extending downward through the deck, and a plurality of blades extending horizontally from the drive shaft. A blade ring extends downward from a bottom surface of the mower deck and is configured such that a bottom edge of the blade ring is located above a path of a middle portion of the blades, and a plurality of sprayer nozzles extend downward from the bottom surface of the mower deck inside the blade ring. A chemical source is operative to deliver pressurized liquid chemical through the chemical conduits to each sprayer nozzle.

This invention is in the field of equipment for controlling vegetation growth and in particular a rotary mower that includes a chemical spraying system.

### BACKGROUND

Rotary mowers are used to cut vegetation such as grass, brush, small trees, and the like in many different situations. Where it is desired to slow re-growth and reduce the necessity to cut the same area again, it is known to apply liquid chemicals such as growth regulators, herbicides, pesticides, fungicides, or the like to vegetation as it is being cut with a rotary mower.

A problem with such rotary mower chemical application systems is that simply mounting spray nozzles under the mower deck exposes the nozzles to material being moved at speeds by the rotating mower blades, and thus are subject to damage and plugging.

Mowers with chemical application systems are disclosed for example in U.S. Pat. Nos. 6,125,621 and 6,374,586 to Burch and 4,926,622 to McKee where the disclosed apparatuses includes a tank and pump, and a conduit network through or around the rotating drive shaft and then along the arms of the blades. Considerable machining and fitting is required and also seals to connect the pressurized liquid chemical from the pump to the rotating shaft, so these systems are costly to manufacture and maintain.

U.S. Pat. No. 5,329,752 to Milbourn discloses a brush cutter that includes a spray nozzle and where the rotating blades of the brush cutter are stopped when vegetation has been cut and then the cut area is sprayed from the nozzle, thus requiring two passes over the area.

U.S. Pat. No. 6,101,798 to Thagard et al. discloses mower with sprayer nozzles disposed in the housing rearward of the cutting blades and oriented to spray chemicals onto the stubble after the stubble has passed behind the cutting blade. The nozzles are exposed to cut material moving at high speed and are subject to plugging and damage.

U.S. Pat. No. 5,237,803 to Domingue, Jr. discloses a rotary mower with a chemical application apparatus where chemical is directed onto a ring attached to the blade such that the liquid is discharged through apertures in the ring when the blade spins at high speed spreading the chemical under the deck and onto the vegetation.

### SUMMARY OF THE INVENTION

It is an object of the present invention to provide a rotary mower apparatus and method for applying liquid chemical that overcomes problems in the prior art.

In a first embodiment the present invention provides a rotary mower apparatus for applying liquid chemical to vegetation. The apparatus comprises a mower deck adapted for movement along the ground in an operating travel direction. A drive shaft extends downward through the mower deck, and a drive mechanism is mounted to a top surface of the mower deck and connected to rotate the drive shaft, and a plurality of blades extend substantially horizontally from the drive shaft. A blade ring extends downward from a bottom surface of the mower deck and is configured such that a bottom edge of the blade ring is located above a path of a middle portion of the blades, and a plurality of sprayer nozzles extend downward from the bottom surface of the mower deck inside the blade ring. A chemical conduit is connected to an input end of each sprayer nozzle located above a top surface of the mower deck, and a chemical source is operative to deliver pressurized liquid chemical through the chemical conduits to each sprayer nozzle.

In a second embodiment the present invention provides a method of applying liquid chemical to vegetation with a rotary mower, the rotary mower comprising mower deck adapted for movement along the ground in an operating travel direction, a drive shaft extending downward through the mower deck, and a drive mechanism mounted to a top surface of the mower deck and connected to rotate the drive shaft, a plurality of blades extending substantially horizontally from the drive shaft, and a blade ring extending downward from a bottom surface of the mower deck and configured such that a bottom edge of the blade ring is located above a path of a middle portion of the blades. The method comprises mounting a plurality of sprayer nozzles extending downward from the bottom surface of each mower deck such that an input end of each sprayer nozzle is above the top surface of the mower deck and an output end of each sprayer nozzle is inside the blade ring; rotating the drive shaft and moving the mower deck through the vegetation in the operating travel direction, and pumping pressurized liquid chemical to each sprayer nozzle such that liquid chemical contacts the blades inside the blade ring and is dispersed over the vegetation

Plugging and damage to the nozzles is reduced by placing them inside the blade ring compared to nozzles that are under the deck outside the blade ring.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic bottom view of an embodiment of a rotary mower apparatus of the present invention;

FIG. 2 is a schematic detail view showing the sprayer nozzle extending through the mower deck in the embodiment of FIG. 1;

FIG. 3 is a top view of an alternate embodiment of a rotary mower apparatus of the present invention comprising right and left wing mower decks attached to a center deck;

FIG. 4 is a rear view of the embodiment of FIG. 3;

FIG. 5 is a bottom view of the embodiment of FIG. 3.

### DETAILED DESCRIPTION OF THE ILLUSTRATED EMBODIMENTS

FIG. 1 schematically illustrates a bottom view of an embodiment of a rotary mower apparatus 1 of the present invention for applying liquid chemical to vegetation. The apparatus 1 comprises a mower deck 3 adapted for movement along the ground in an operating travel direction T. The illustrated deck 3 is mounted on wheels 5 but could also be mounted directly to a tractor as is known in the art.

A drive shaft 7 extends downward through the mower deck 3, and a drive mechanism mounted to a top surface of the mower deck 3 and thus not visible in FIG. 1 is connected to rotate the drive shaft 7, and a plurality of blades 9 extend substantially horizontally from the drive shaft 7. A blade ring 11 extends downward from the bottom surface of the mower deck 3 and is configured such that a bottom edge of the blade ring 11 is located above a path of a middle portion of the blades 9 as the blades move in a circular path P. The illustrated blade ring 11 is circular but it is also known to provide such a blade ring 11 using a plurality of straight wall sections welded to form the ring.

A plurality of sprayer nozzles 13 extend downward from the bottom surface of the mower deck 3 inside the blade ring 11 where they are protected from the majority of the cut vegetation material that moves at high speed in response to contact with the rapidly spinning blades 9. Plugging and damage to the nozzles 13 is thus reduced compared to nozzles that are under the deck outside the blade ring 11.

As schematically illustrated in FIG. 2, an input end 13A of each sprayer nozzle 13 is located above the mower deck 3 and the lower output end 13B is located under the mower deck 3. The sprayer nozzles 13 are spaced across a width of the blade ring 11, and in the illustrated apparatus 1 they are located rearward of the drive shaft 7 and in proximity to the blade ring 11.

In operation the spinning blades 13 create considerable air movement which carries the liquid chemical outside the blade ring 11 and the air turbulence distributes the liquid chemical satisfactorily on the vegetation cut by the blades 13 under the mower deck 3. It is contemplated that the position of the nozzles 13 will thus not be critical to satisfactory operation of the apparatus 1.

FIGS. 3-5 schematically illustrate respective top, rear, and bottom views of an alternate apparatus 101 for cutting a wider swath of vegetation and applying liquid chemical to the vegetation left standing after top portions thereof have been cut off by the mower blades. The liquid chemical can serve various desired purposes, such as for reducing and slowing re-growth of the vegetation.

The apparatus 101 comprises a center mower deck 103C, and right and left wing mower decks 103R, 103L pivotally attached to corresponding right and left sides of the center mower deck 103C. The mower decks 103 are adapted for movement along the ground in an operating travel direction T by wheels, skids, or the like which are not shown.

A drive shaft 107 extends downward through each mower deck 103, and a drive mechanism 115 mounted to a top surface of each mower deck 103 is connected to rotate the drive shaft 107. A plurality of blades 109 extend horizontally from each drive shaft 107. In the illustrated apparatus 101 the blades are pivotally connected to a blade pan 117, such as is known in the art.

A blade ring 111 extends downward from the bottom surface of each mower deck 103 and is configured such that a bottom edge of the blade ring 111 is located above a path of a middle portion of the blades 109. A plurality of sprayer nozzles 113 extending downward from the bottom surface of each mower deck 113 inside the blade ring 111. As schematically shown in FIG. 3 a chemical conduit 119 is connected to the input end 113A of each sprayer nozzle 113 located above a top surface of the mower deck 103 and a chemical source delivers pressurized liquid chemical through the chemical conduits 119 to each nozzle 113. The conduits 119 are not shown in FIGS. 4 and 5.

In the illustrated apparatus 101 the chemical source comprises a chemical reservoir 121 mounted to a top of the center mower deck 103C and a pump 123 operative to pump liquid chemical through the chemical conduits 119 to each nozzle 113. Chemical is delivered to the sprayer nozzles 113 on each of the decks 103R, 103C, 103L by separate conduits 119R, 119C, 119L such that a valve 125 can control flow of liquid chemical to sprayer nozzles on each mower deck 103 by directing pressurized liquid chemical into selected conduits 119. Thus the sprayer nozzles 113 on each of the decks 103R, 103C, 103L can be turned on or off if desired, such as to reduce overlap of chemical application.

The invention thus provides a method of applying liquid chemical to vegetation with a rotary mower, where the rotary mower comprises a mower deck 3, 103 adapted for movement along the ground in an operating travel direction T, a drive shaft 7, 107 extending downward through the mower deck 3, 103, and a drive mechanism 115 mounted to a top surface of the mower deck 3, 103 and connected to rotate the drive shaft 7, 107, a plurality of blades 9, 109 extending horizontally from the drive shaft, and a blade ring 11, 111 extending downward from a bottom surface of the mower deck and configured such that a bottom edge of the blade ring 11, 111 is located above a path of a middle portion of the blades 9, 109. The method comprises mounting a plurality of sprayer nozzles 13, 113 extending downward from the bottom surface of each mower deck 3, 103 such that an input end 13A, 113A of each sprayer nozzle 13, 113 is above the top surface of the mower deck and an output end 13B of each sprayer nozzle is inside the blade ring 11; rotating the drive shaft 7, 107 and moving the mower deck 3, 103 through the vegetation in the operating travel direction T, and pumping pressurized liquid chemical to each sprayer nozzle 13, 113 such that liquid chemical contacts the blades 9, 109 inside the blade ring 11, 111 and is dispersed over the vegetation.

In the present invention the sprayer nozzles are inside the blade ring and so protected from a large part of the cut vegetation material that is moving at high speed after contact with the rapidly spinning blades. Damage and plugging of nozzles is reduced.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A rotary mower apparatus for applying liquid chemical to vegetation, the apparatus comprising:
a mower deck adapted for movement along the ground in an operating travel direction;
a drive shaft extending downward through the mower deck, and a drive mechanism mounted to a top surface of the mower deck and connected to rotate the drive shaft;
a plurality of blades extending substantially horizontally from the drive shaft;
a blade ring fixed to and extending downward from a bottom surface of the mower deck and configured such that a stationary bottom edge of the blade ring is located above a path of a middle portion of the blades;
a plurality of sprayer nozzles extending downward from the bottom surface of the mower deck inside the blade ring;
a chemical conduit connected to an input end of each sprayer nozzle located above a top surface of the mower deck; and
a chemical source operative to deliver pressurized liquid chemical through the chemical conduits to each sprayer nozzle.

2. The apparatus of claim 1 wherein the sprayer nozzles are spaced across a width of the blade ring.

3. The apparatus of claim 2 wherein the sprayer nozzles are located rearward of the drive shaft.

4. The apparatus of claim 1 wherein the sprayer nozzles are in proximity to the blade ring.

5. The apparatus of claim 1 comprising a center mower deck and right and left wing mower decks pivotally attached to corresponding right and left sides of the center mower deck, the mower decks adapted for movement along the ground in an operating travel direction;
a drive shaft extending downward through each mower deck, and a drive mechanism mounted to a top surface of each mower deck and connected to rotate the drive shaft;
a plurality of blades extending substantially horizontally from each drive shaft;
a blade ring extending downward from a bottom surface of each mower deck and configured such that a bottom edge of the blade ring is located above a path of a middle portion of the blades;
a plurality of sprayer nozzles extending downward from the bottom surface of each mower deck inside the blade ring;
a chemical conduit connected to an input end of each sprayer nozzle located above a top surface of the mower deck; and
a chemical source operative to deliver pressurized liquid chemical through the chemical conduits to each sprayer nozzle.

6. The apparatus of claim 5 wherein the chemical source comprises a chemical reservoir mounted to a top of the center mower deck and a pump operative to pump liquid chemical through the chemical conduits to each sprayer nozzle.

7. The apparatus of claim 5 comprising a valve operative control flow of liquid chemical to sprayer nozzles on each mower deck.

8. A method of applying liquid chemical to vegetation with a rotary mower, the rotary mower comprising a mower deck adapted for movement along the ground in an operating travel direction, a drive shaft extending downward through the mower deck, and a drive mechanism mounted to a top surface of the mower deck and connected to rotate the drive shaft, a plurality of blades extending substantially horizontally from the drive shaft, and a blade ring fixed to and extending downward from a bottom surface of the mower deck and configured such that a stationary bottom edge of the blade ring is located above a path of a middle portion of the blades, the method comprising the steps of:
mounting a plurality of sprayer nozzles extending downward from the bottom surface of each mower deck such that an input end of each sprayer nozzle is above the top surface of the mower deck and an output end of each sprayer nozzle is inside the blade ring;
rotating the drive shaft and moving the mower deck through the vegetation in the operating travel direction, and
pumping pressurized liquid chemical to each sprayer nozzle such that liquid chemical contacts the blades inside the blade ring and is dispersed over the vegetation.
